(19) United States
(12) Patent Application Publication
(10) Pub. No.: US 2006/0084409 A1
(43) Pub. Date: Apr. 20, 2006

(54) Systems for and methods of programming a remote control

(76) Inventor: Muffaddal Ghadiali, Campbell, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/965,993

(22) Filed: Oct. 15, 2004

(51) Int. Cl. H04B 1/18; H04N 5/232; H04B 1/06; H04M 3/00

(52) U.S. Cl. 455/352; 455/151.1; 455/420; 348/734; 348/211.99; 340/426.13

(57) ABSTRACT

A remote control comprises a receiver and a configuration circuit. The receiver is operable to receive a programming signal that includes programming instructions corresponding to an electronic device, and the configuration circuit is coupled to the receiver and is operable to configure the remote control according to the programming instructions such that the remote control is operable to control the electronic device.

### BACKGROUND

Remote controls for televisions, stereo systems and other electronic devices are well known in the art. Also well known is the universal remote control that is capable of controlling multiple devices of different types and makes.

A problem associated with these universal remote controls is the need to program them. For each device for which the remote control is to be used, the user manually programs the remote control with a code identifying the device. To program the remote control, the user first locates the code and then enters the code into the remote control, usually by a series of keystrokes on the remote control keypad. This manner of programming a remote control can be time consuming and, for some, confusing.

### SUMMARY

According to an embodiment of the present invention, a remote control comprises a receiver and a configuration circuit. The receiver is operable to receive a programming signal that includes programming instructions corresponding to an electronic device, and the configuration circuit is coupled to the receiver and is operable to configure the remote control according to the programming instructions such that the remote control is operable to control the electronic device.

### BRIEF DESCRIPTION OF THE DRAWINGS

FIG. 1 is a schematic view of a system according to an embodiment of the invention;

FIG. 2 is a functional block diagram of the system illustrated in FIG. 1 according to an embodiment of the invention; and

FIG. 3 is a flow diagram of a method according to an embodiment of the invention.

### DETAILED DESCRIPTION

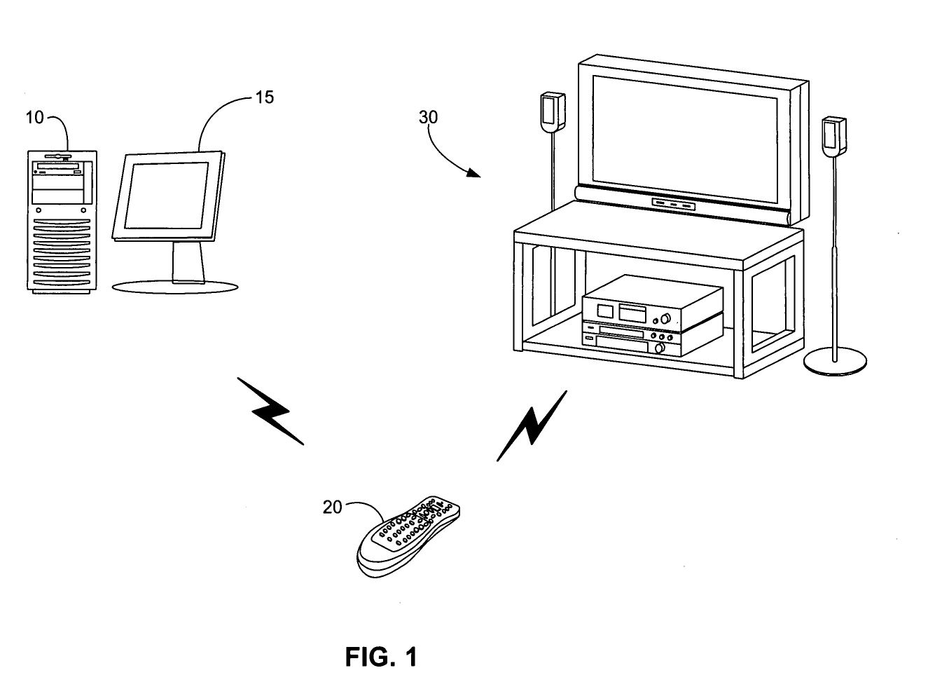

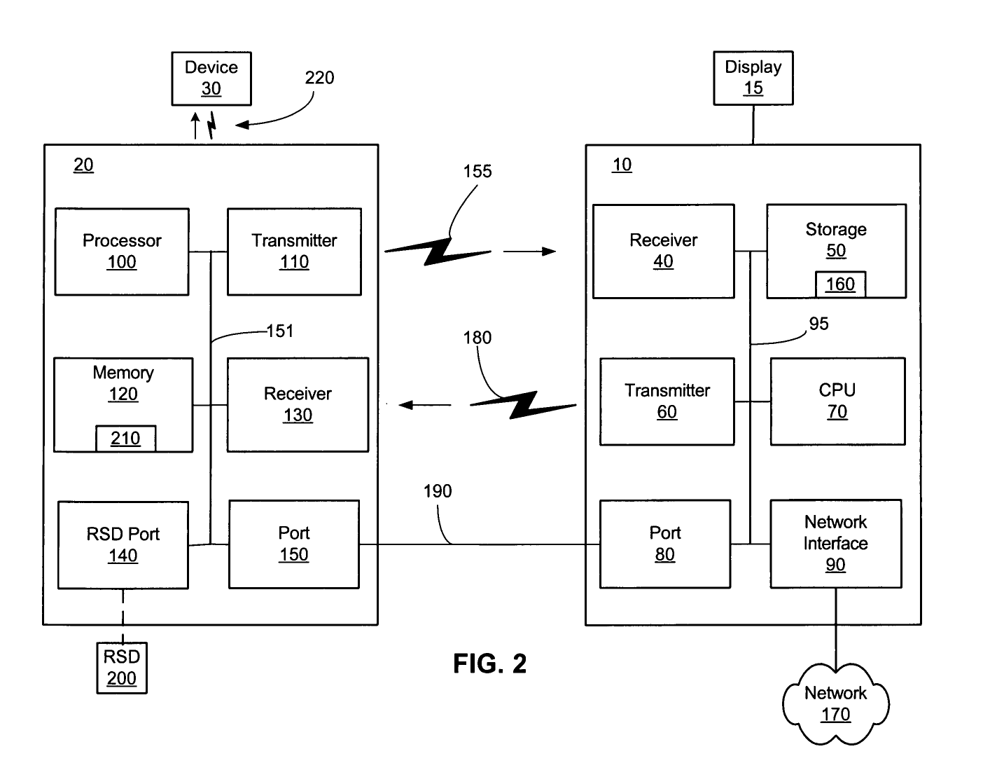

FIG. 1 is a schematic view of a computer 10 coupled to a display 15, and a remote control 20, according to an embodiment of the invention. The computer 10 may be, for example, a Media Center PC produced by the Hewlett-Packard Company. As discussed more fully with reference to FIG. 2, the computer 10 is operable to program the remote control 20 to control one or more electronic devices 30. The devices 30 may include, for example, televisions, stereo receivers, multimedia recording devices, and any other electronic device controllable by remote control signals, including the computer 10 itself.

Specifically, the computer 10 is operable to access a data set, such as programming instructions, and transmit the data set to the remote control 20 via an electromagnetic signal such as an infrared (IR) or radio frequency (RF) signal. From this data set, the remote control 20 is able to identify a device 30 over which the remote control 20 is to exercise control. Consequently, in response to the data set, the remote control 20 programs itself to generate control signals to which the device 30 will respond.

Referring to FIG. 2, the computer 10 includes the following components: a receiver 40, a storage device 50 such as a hard disk drive, a transmitter 60, a central processing unit (CPU) 70, a port 80, and a network interface 90 according to an embodiment of the invention. A bus 95 couples the computer components to one another. In an alternative embodiment, the receiver 40 and/or transmitter 60 may be peripheral devices coupled to the computer 10.

The remote control 20 includes the following components: a configuration circuit such as a processor 100, a transmitter 110, a memory 120, a receiver 130, a removable storage device (RSD) port 140, and a port 150 according to an embodiment of the invention. A bus 151 couples the remote control components to one another.

In operation, according to an embodiment of the invention, a user wishing to program the remote control 20 to control the device 30 identifies the device to the computer 10.

For example, the user may prompt the computer 10 to execute a software application with which the user may interact via a user interface (not shown) generated on the display 15. The software application may prompt the user to input information identifying the device 30, such information including, for example, the device type (e.g., television, stereo receiver, VCR, etc.), the manufacturer name, and model number, or other identification data. This identifying information may be input to the computer 10 using, for example, a keyboard (not shown), mouse (not shown), or any other input device.

Alternatively, the user may employ the remote control 20 to input to the computer 10 the information identifying the device 30. Specifically, the user may operate the remote control 20 such that the remote control transmitter 110 transmits signals 155 to the receiver 40. Via these signals 155, the user may use the remote control 20 to make selections using a cursor and menu that the computer 10 generates on the display 15. The signals 155 may be IR signals, RF signals that conform to a communication protocol such as Bluetooth, or any other wireless signals.

After receiving an identification of the device 30 to be controlled by the remote control 20, the CPU 70 consults a table 160 of programming instructions that reside in the storage device 50. Alternatively, the CPU 70 may access, via the network interface 90, a similar table (not shown) of programming instructions stored, for example, on a remote server (not shown) associated with a network 170 such as a local-area network (LAN) or a wide-area network (WAN) such as the Internet. The programming instructions stored in the table 160 uniquely identify or otherwise correspond to different electronic devices. The programming instructions may include multiple-digit programming codes, raw programming data (e.g., data encoded using pulse-width or pulse-space modulation), or other programming formats.

Still referring to FIG. 2, the CPU 70 identifies the instructions corresponding to the device 30 and communicates the instructions to the remote control 20. The transmitter 60 transmits the instructions via signals 180 to the receiver 130 of the remote control 20. The signals 180 may be IR signals or other types of wireless communication signals. Alternatively, the CPU 70 can employ the port 80 to communicate the instructions over a cable 190 to the port 150 of the remote control 20. The ports 80 and 150 may operate according to any plug-and-socket connection standard such as Universal Serial Bus or IEEE 1394, which are known in the art. Alternatively, a RSD port (not shown) of the computer 10 may receive a RSD 200 such as a solid-state CompactFlash device. Consequently, the CPU 70 may store the instructions on the RSD 200. The user can then disconnect the RSD 200 from the computer 10 and connect it to the RSD port 140 of the remote control 20 so that the remote control can download the instructions from the RSD via the RSD port.

Upon receiving the instructions from the computer 10, the processor 100 of the remote control 20 configures itself to control the specified device 30. For example, the processor 100 may consult a look-up table 210 residing in the memory 120. The look-up table 210 may contain control signal information, such as pulse lengths and sequences, corresponding to each type of device 30 over which the remote control 20 may exercise control. Based on the programming instructions, the processor 100 may use the corresponding control signal information to cause the transmitter 110 to emit command signals 220 to which the device 30 responds.

In one embodiment, prior to programming the remote control 20 in the manner described above, a user enters the remote control 20 into a “programming mode” by, for example, a predetermined series of keystrokes to a keypad (not shown) of the remote control. Alternatively, prior to communicating the programming instructions to the remote control 20, the computer 10 may instruct the remote control 20 to enter the programming mode. By limiting programming of the remote control 20 to instances in which the remote control is in the programming mode, inadvertent programming of the remote control by the computer 10 may be avoided.

Subsequent to, or in the process of, entering the remote control 20 into programming mode, the user may specify the type of device 30 for which the remote control 20 will be programmed. For example, the remote control keypad (not shown) may include keys respectively corresponding to a television, a stereo receiver, a set-top box, etc. Consequently, if the user wishes to program the remote control 20 to control a television set, the user may press, alone or in combination with other keys, a UTV“key of the keypad prior to receiving programming instructions from the computer 10.

Other embodiments of the arrangement shown in FIGS. 1 and 2 are contemplated. For example, the remote control 20 and computer 10 may respectively include more or fewer than all of the components illustrated in FIG. 2. For example, if the computer 10 and remote control 20 communicate only via a wireless channel, then the remote control may omit the RSD port 140 and/or the port 150.

In another embodiment, the device 30 provides to the remote control 20 programming instructions operable to configure the remote control to control the device in a manner similar to that described above for the computer 10. For example, the device 30 may be configured to detect a signal issued by the remote control 20, the signal causing the device to recognize that a user desires that the device program the remote control and to which the device responds by transmitting programming instructions to the remote control. Alternatively, the device 30 may include a display device (not shown) that, in response to detecting a signal issued by the remote control 20, may display a menu that allows the user to identify to the device the type (e.g., brand) of remote control that the user desires that the device program. Alternatively, the device 30 may include a button (not shown) or other manually operable interface that enables the user to cause the device to program the remote control 20.

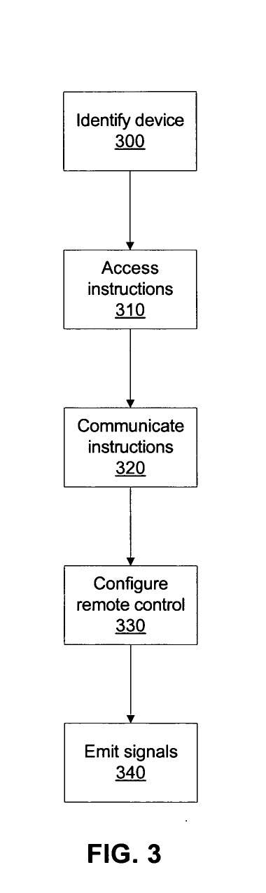

FIG. 3 illustrates a process of programming the remote control 20 of FIGS. 1 and 2 according to an embodiment of the invention. Beginning at a step 300, a user wishing to program the remote control 20 to control a device 30 identifies the device to the computer 10. After receiving an identification of the device 30, at a step 310 the computer 10 accesses programming instructions corresponding to the device. Subsequently, at a step 320, the computer 10 communicates the programming instructions to the remote control 20. At a step 330, in response to the programming instructions, the processor 100 of the remote control 20 configures the remote control to control the device 30. Consequently, at a step 340, the remote control 20 emits command signals 220 to which the device 30 responds.

Computer program code for carrying out operations of embodiments of the present invention, such as, for example, the described operation of the CPU 70, may be written in an object-oriented programming language, such as JAVA, Smalltalk, or C++. Computer program code for carrying out these operations may also, however, be written in conventional procedural programming languages, such as the C programming language or compiled Basic (CBASIC). Furthermore, some modules or routines may be written in assembly language or even micro-code to enhance performance and/or memory usage. In addition, at least one carrier signal may be modulated with computer program code for carrying out the described operations.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A remote control, comprising:
a receiver operable to receive a programming signal that includes programming instructions corresponding to an electronic device; and
a configuration circuit coupled to the receiver and operable to configure the remote control according to the programming instructions such that the remote control is operable to control the electronic device.

2. The remote control of claim 1 wherein the receiver is operable to receive the programming signal from the electronic device.

3. The remote control of claim 1 wherein the receiver is operable to receive the programming signal from a programming device other than the electronic device.

4. The remote control of claim 1 wherein the programming instructions comprise a programming code.

5. The remote control of claim 1, further comprising a look-up table coupled to the configuration circuit and operable to associate the programming instructions to the electronic device.

6. The remote control of claim 1 wherein the programming signal comprises a wireless signal.

7. The remote control of claim 1 wherein the configuration circuit comprises a processor.

8. A programming device operable to provide to a remote control a programming signal that includes programming instructions corresponding to an electronic device, the programming instructions operable to configure the remote control to control the electronic device.

9. The programming device of claim 8 wherein the programming device comprises a personal computer.

10. The programming device of claim 8 wherein the programming device comprises the electronic device.

11. A system, comprising:
a programming device operable to store remote-control programming instructions corresponding to an electronic device; and
a remote control, comprising:
a receiver operable to receive the programming instructions from the programming device; and
a configuration circuit coupled to the receiver and operable to configure the remote control according to the programming instructions such that the remote control is operable to control the electronic device.

12. The system of claim 11 wherein the programming device comprises a personal computer.

13. The system of claim 11 wherein the programming device comprises the electronic device.

14. The system of claim 11 wherein the remote control is operable to control the programming device.

15. A system, comprising:
an electronic device; and
a remote control, comprising,
a receiver operable to receive a programming signal that includes programming instructions corresponding to the electronic device; and
a configuration circuit coupled to the receiver and operable to configure the remote control according to the programming instructions such that the remote control is operable to control the electronic device.

16. The system of claim 15 wherein the receiver is operable to receive the programming signal from the electronic device.

17. A method, comprising:
receiving with a remote control a programming signal that includes programming instructions corresponding to an electronic device; and
configuring the remote control according to the programming instructions such that the remote control is operable to control the electronic device.

18. The method of claim 17 wherein the programming instructions comprise a programming code.

19. The method of claim 17 wherein the programming signal comprises a wireless signal.

20. A method, comprising:
sending to a remote control a programming signal that includes programming instructions corresponding to an electronic device, the programming instructions operable to configure the remote control to control the electronic device.

21. The method of claim 20 wherein the programming instructions comprise a programming code.

22. The method of claim 20 wherein the programming signal comprises a wireless signal.

23. An article of manufacture, comprising: a machine-readable medium having stored thereon instructions, that when executed by a processor, are operable to cause the processor to:
provide to a remote control a programming signal that includes programming instructions corresponding to an electronic device, the programming instructions operable to configure the remote control to control the electronic device.

24. The article of claim 23 wherein the machine-readable medium comprises a modulated carrier signal.
